(19) United States
(12) Patent Application Publication
(10) Pub. No.: US 2026/0151773 A1
(43) Pub. Date: Jun. 4, 2026

(54) WEAR COMPONENT INSTALLATION AND RETENTION SYSTEMS FOR JAW CRUSHERS

(71) Applicant: Astec Industries, Inc., Chattanooga, TN (US)

(72) Inventors: Robert Wheeler, Chattanooga, TN (US); Mathew Jones, Chattanooga, TN (US); Martin Botha, Chattanooga, TN (US)

(73) Assignee: Astec Industries, Inc., Chattanooga, TN (US)

(21) Appl. No.: 19/409,131

(22) Filed: Dec. 4, 2025

Related U.S. Application Data
(60) Provisional application No. 63/727,942, filed on Dec. 4, 2024.
(60) Provisional application No. 63/727,949, filed on Dec. 4, 2024.

(51) Int. Cl. B02C 1/04; B02C 1/10

(52) U.S. Cl. CPC B02C 1/04; B02C 1/10; B02C 2210/02

(57) ABSTRACT

Systems and methods for installing wear components in a jaw crusher without requiring personnel to enter the crushing chamber. In one aspect, a liner assembly includes locating features that engage corresponding pins on a crusher frame to automatically align the assembly for the installation of external fasteners. In another aspect, a jaw die retention system uses externally operated jacking members to push a retaining wedge and jaw die into a “service position,” allowing the jaw die to be safely rigged and replaced from outside the crusher. The jacking members are then retracted, and an external retaining fastener is tightened to pull the die into its “operational position.” These systems can be applied to both stationary and movable jaws, significantly improving maintenance, safety and efficiency.

### CROSS-REFERENCE TO RELATED APPLICATIONS

This application claims the benefit of priority to U.S. Provisional Application No. 63/727,942, filed Dec. 4, 2024, entitled “CHEEK PLATE,” and U.S. Provisional Application No. 63/727,949, filed Dec. 4, 2024, entitled “WEDGE,” the entire disclosures of which are incorporated herein by reference.

### FIELD OF THE INVENTION

The present invention relates generally to jaw crushers used for crushing rock, ore, and other materials. More particularly, the invention relates to systems and methods for installing and retaining wear components in jaw crushers, including cheek plates (i.e., side liners) and jaw dies, that eliminate or substantially reduce the need for personnel to enter the crushing chamber during installation, removal, and maintenance operations.

### DESCRIPTION OF RELATED ART

Jaw crushers are a widely utilized type of mechanical crushing equipment, typically employed as primary crushers for the size reduction of hard materials like rock and ore. The fundamental design, featuring an oscillating jaw plate moving against a fixed jaw plate, has remained consistent.

With reference to FIG. 1, a conventional jaw crusher 100 includes a main frame 102 that defines a V-shaped crushing chamber 104, which converges from a feed opening 106 at the top to a discharge opening 108 at the bottom. Within the chamber 104, a stationary jaw 110 is mounted to the frame 102, and a movable jaw 112 is suspended from a pivot bearing 114. An electric motor 116 drives a flywheel 118 and an eccentric shaft 120, which imparts a reciprocating motion to the movable jaw 112. A push plate 122 connects the bottom of the movable jaw 112 to the frame 102.

In operation, material M1 is fed into the opening 106 and is progressively crushed as it descends the chamber 104, exiting as crushed material M2 through the discharge opening 108. The actual crushing surfaces are provided by removable wear components called jaw dies 126. Each of the jaw dies 126 has a working face 130 and a back face 132 and is mounted to a jaw backing structure 134. The lateral sidewalls 136 of the crushing chamber 104 are protected by removable wear liners known as cheek plates 138.

Despite refinements in crusher design, the process for replacing wear components like jaw dies 126 and cheek plates 138 remains hazardous. A core problem is that maintenance workers must enter the crushing chamber 104 to perform installation and removal. The crushing chamber 104 is an inherently hazardous, confined space. This entry exposes personnel to severe safety risks, including the need to weld temporary lifting lugs onto worn components (creating toxic manganese fumes and risks of weld failure), and the dangers of removing fasteners and handling multi-ton components from within the chamber. Conventional cheek plate 138 installation systems typically utilize fasteners that are only accessible from inside the crushing chamber 104 and lack integrated lifting provisions, necessitating the hazardous welding operations previously described.

Alternative systems using special “tee bolts” (not shown) have been developed to allow fastening from outside the crusher. However, this approach has significant drawbacks: it requires specially shaped slots in the cheek plates, making them thicker, heavier, and reducing the effective volume of the crushing chamber. Furthermore, these designs often use interdependent segments, negating the economic benefit of replacing only the most worn section, and do not fully eliminate the need for chamber entry if lifting points are damaged.

The persistence of these safety hazards and operational inefficiencies, despite a long history of jaw crusher use and a competitive market, demonstrates a long-felt but unmet need for a comprehensive system that completely eliminates the requirement for personnel to enter the crushing chamber for wear component maintenance.

### SUMMARY OF THE INVENTION

The above and other needs are addressed by embodiments of the present invention which provide systems and methods for installing and retaining crusher wear components that completely eliminate the need for personnel to enter the crushing chamber. The disclosed embodiments provide a comprehensive solution applicable to both jaw dies and cheek plates (i.e., side liners) on both stationary and movable jaws, dramatically improving safety and reducing maintenance downtime.

In one aspect, a liner assembly is provided. The assembly includes an upper liner segment and a lower liner segment connected by fasteners. The upper segment features an integrated lifting hole positioned above the assembly's center of mass, ensuring it hangs in a stable, predetermined orientation for installation. The lower segment features at least two locating tabs. During installation, the liner assembly is lowered into the crusher, and the locating tabs, which preferably include beveled guide surfaces, engage with corresponding locating pins provided on the jaw crusher, such as on the frame. This engagement automatically guides the liner assembly into a precise position where its fastener holes align with the frame's fastener holes. Frame fasteners can then be installed and tightened entirely from the exterior of the crusher. This system ensures safe, rapid, and precise installation without any personnel being located inside the crushing chamber.

In another aspect, a jaw die retention system is provided. The system includes a reusable retaining wedge configured to be positioned behind an upper end of the jaw die, thereby shielding the wedge from abrasive wear within the crushing chamber, and a jacking member (e.g., a threaded bolt or hydraulic cylinder) having an end that is accessible from the exterior of the jaw crusher. To remove a jaw die, retaining fasteners are loosened, and the jacking member is advanced to push the wedge and jaw die outward into a “service position.” In this position, the jaw die is securely supported by the wedge and jacking member, displaced from the jaw backing structure, allowing rigging to be safely attached from above. To install a new die, it is lowered and leaned against the wedge in the service position. The jacking member is then retracted, allowing the jaw die and wedge to slide inward, preferably aided by gravity on an angled jaw backing structure (preferably angled at least 5 degrees from vertical). Retaining fasteners are then tightened from the exterior to lock the die in its “operational position.” This system enables complete jaw die replacement on both stationary and movable jaws without personnel ever entering the crushing chamber.

By combining these systems, a jaw crusher is provided wherein all major wear components in the crushing chamber can be replaced entirely from the exterior, representing a fundamental advance in crusher safety and maintenance efficiency.

### BRIEF DESCRIPTION OF THE DRAWINGS

FIG. 1 is a cutaway side elevation view depicting an internal structure of a conventional jaw crusher;

FIG. 2 is a cutaway side elevation view depicting an internal structure of a jaw crusher having a liner assembly and a jaw die retention system according to embodiments of the present invention;

FIG. 2A is a detail view of a crushing chamber of the jaw crusher of FIG. 2;

FIG. 3 is an exploded view of a movable jaw of the jaw crusher of FIG. 2 illustrating components of the jaw die retention system;

FIG. 4 is a cross-sectional view of the jaw die retention system of FIG. 3;

FIG. 4A and FIG. 4B are detail views of a portion of FIG. 4 labeled “DETAIL 1” that depict die retainers according to alternative embodiments of the present invention;

FIG. 4C is a detail view of a portion of FIG. 4 labeled “DETAIL 2” that depicts a retaining wedge according to an embodiment of the present invention;

FIGS. 5-7 are cross-sectional views depicting a jaw die being mounted to a jaw backing structure using the jaw die retention system shown in FIG. 3, including the wedge detailed in FIG. 4C;

FIG. 8 is an elevation view depicting a liner assembly being mounted to a jaw crusher frame side plate of the jaw crusher of FIG. 2;

FIGS. 9 and 10 are detail views of a portion of FIG. 8 labeled “DETAIL 3” that depict a connection fastener passing through corresponding connection apertures to removably connect together upper and lower liner segments of the liner assembly; and

FIGS. 11 and 12 are elevation views depicting the liner assembly of FIG. 8 being lowered and installed onto a jaw crusher frame side plate of the jaw crusher of FIG. 2.

### NOTES ON CONSTRUCTION

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

### DETAILED DESCRIPTION OF THE INVENTION

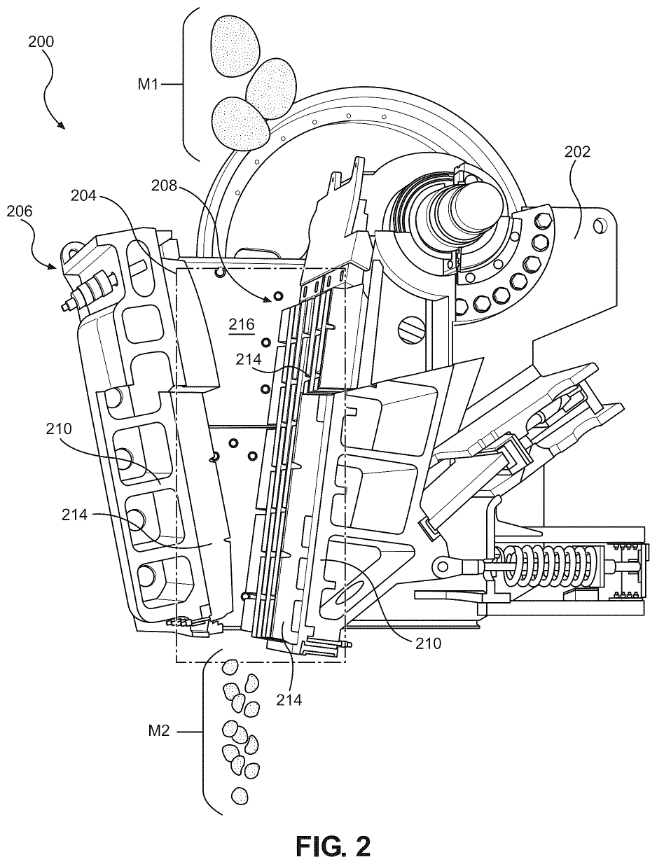

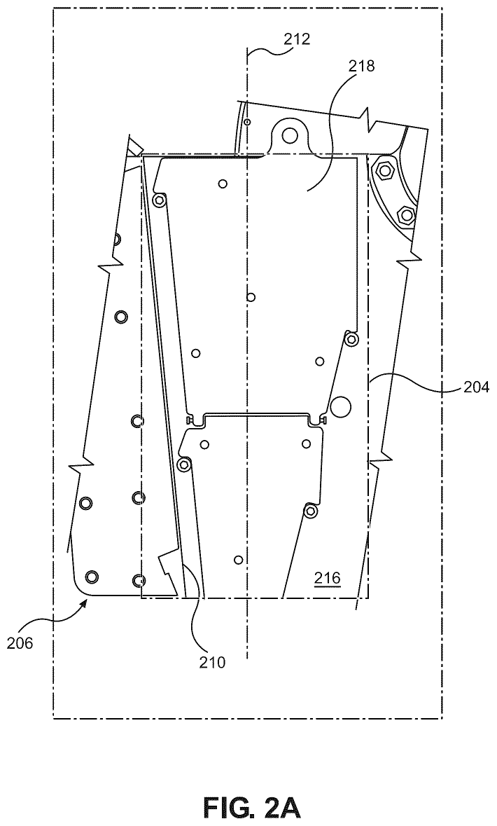

Referring now to the drawings, wherein like reference numerals designate corresponding parts throughout the several views, FIG. 2 and FIG. 2A illustrates a cutaway side elevation view of a jaw crusher 200 having wear component systems according to embodiments of the present invention. The crusher 200 includes a crusher frame 202 that defines a crushing chamber 204 between a stationary jaw 206 and a movable jaw 208. Each of the jaws 206, 208 includes a jaw backing structure 210 that is preferably angled at a minimum of 5 degrees from vertical, as illustrated between jaw backing structure of stationary jaw 206 and axis 212. This creates a V-shaped crushing chamber 204 that facilitates not only gravity-assisted movement of material M1 through the crusher 200 to form crushed material M2 but also gravity-assisted vertical movement of wear components during maintenance activities into and out of the crushing chamber.

Preferably, the stationary jaw 206 and the movable jaw 208 are each protected by a replaceable jaw die 214 (i.e., a first wear component according to an embodiment of the present invention). Additionally, the jaw crusher 200 includes opposing and preferably structurally similar sidewalls 216 (one of which is shown in FIG. 2) that extend between stationary jaw 206 and the movable jaw 208 to enclose the crushing chamber 204. Preferably, each of the sidewalls 216 is protected by a removable wear liner 218 (i.e., a second wear component according to an embodiment of the present invention, shown in FIG. 2A).

As further discussed below, gravity-assisted vertical movement of these wear components 216, 218 is an important feature for the safe and efficient operation of both the jaw die retention system and the liner assembly system of the present invention and that are detailed in this description. A primary advantage of these systems is that they eliminate entirely the need for personnel to enter the jaw crusher 200, including particularly the crushing chamber 204. Instead, mounting components for the wear components 216, 218 are externally accessible and the wear components can be replaced while all personnel remain safely and exclusively outside the crushing chamber 204. Preferably, because all fastening and jacking components are accessible from the exterior of the crusher, both installation and removal of the jaw die 214 are performable by a single operator, greatly reducing labor requirements.

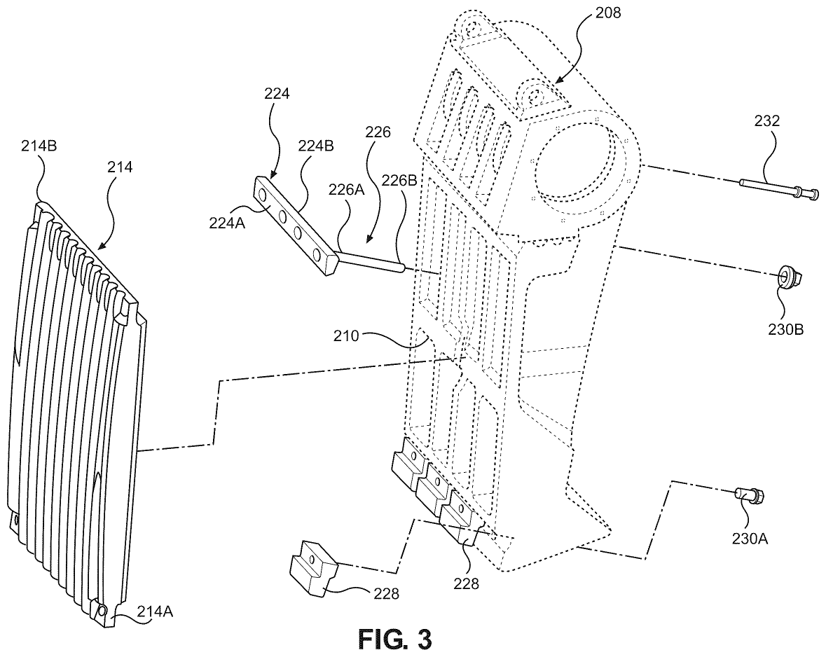

With continued reference to FIG. 2 and with further reference to FIG. 3, the primary components of the jaw die retention system include the replaceable jaw die 214, a reusable retaining wedge 224 having a wedge face 224A for contacting the jaw die 214 and a back face 224B, a wedge bolt 226, one or more die retainers 228, one or more retaining fasteners 230 (e.g., fasteners 230A and/or wedge nut 230B), and one or more jacking members (e.g., jack bolts) 232. As detailed below, in use, components of the jaw die retention system are preferably used to mount a jaw die 214 to at least one of the stationary jaw 206 and the movable jaw 208. Significantly, because the retaining wedge 224 is configured to be positioned entirely behind the replaceable jaw die 214 when installed, it is shielded from contact with material M1 being crushed and is therefore not a primary wear component, making it reusable across multiple jaw die replacement cycles.

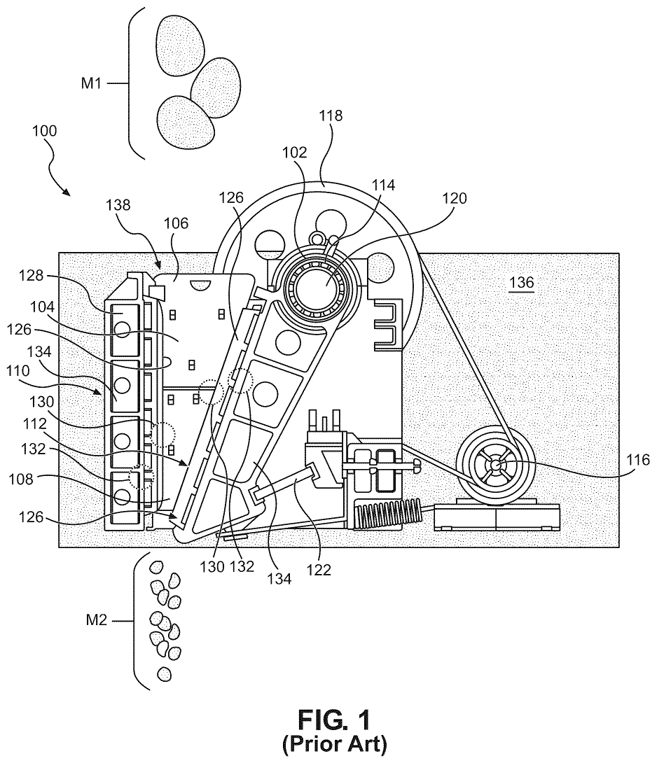

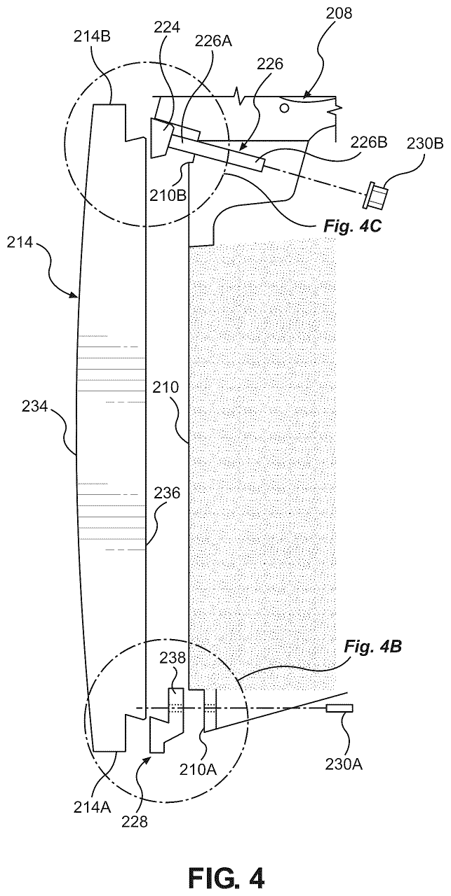

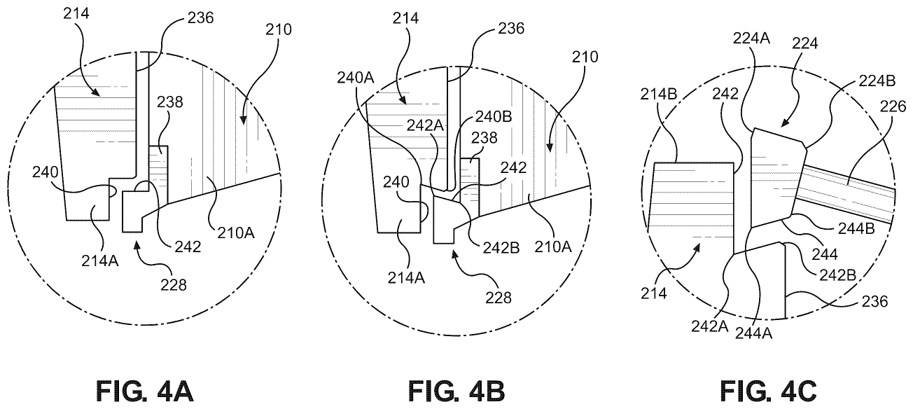

With continued reference to FIG. 3 and with further reference to FIG. 4, each of a lower end 214A and an upper end 214B of the jaw die 214 is preferably securely mounted to the jaw backing structure 210 using the jaw die retention system. The jaw die 214 provides a front (i.e., crushing) face 234 that contacts material being crushed by the crusher 200 and that is worn down during crushing operations along with an opposing rear (mounting) face 236 that is used to mount the jaw die to the jaw backing structure 210. Preferably, the jaw die 214 also includes one or more integrated lifting provisions, such as cast or threaded holes, configured to receive lifting shackles or other lifting equipment. When the jaw die 214 is worn and must be replaced, this system enables the die retainer to be replaced by personnel located entirely outside the crusher 200 including particularly the crushing chamber 204 (FIG. 1). In preferred embodiments, the lower end 214A of the jaw die 214 mounts to a lower end 210A of jaw backing structure 210 via one or more of the die retainers 228 and the upper end 214B of the jaw die mounts to an upper end 210B of jaw backing structure via the retaining wedge 224 and wedge bolt 226.

In the illustrated embodiment, the wedge bolt 226 comprises a rod having an attachment end 226A that is attached to the back face 224B of the wedge 224 and an opposing threaded free end 226B. The wedge bolt 226 extends through the jaw backing structure 210 at an angle such that the free end 226B is located vertically lower than the attachment end 226A that is mounted to the wedge 224. The wedge 224 can be moved via the wedge bolt 226 and then secured in a selected position using wedge nut 230B. In particular, by threading the wedge nut 230B further onto the free end 226B, both the wedge bolt 226 and the wedge 224 are drawn closer towards the jaw backing structure 210 and are selectively fixed in place. Conversely, backing the wedge nut 230B out allows the wedge bolt 226 to move freely away from the jaw backing structure 210. To push the wedge bolt 226 away from the jaw backing structure 210, jacking bolts 232 may be threaded into threaded openings (not shown) in the jaw backing structure 210. Then, as the jacking bolts 232 are threaded further into those openings, opposing ends of the jacking bolts make contact with and apply a force to the wedge 224 to push the wedge away from the jaw backing structure 210. Due to its inclined orientation, when the wedge bolt 226 pushes the wedge 224 away from the jaw backing structure 210, the wedge is also raised in a vertical direction. Conversely, when the wedge 224 is drawn towards the jaw backing structure 210, it is also lowered in a vertical direction. As discussed further below, this vertical movement is important for automatically securing the jaw die 214 against the jaw backing structure 210.

With reference to FIG. 4A, each die retainer 228 is preferably attached to the jaw backing structure 210 jaw die 214 by placing a rear flange 238 of the die retainer into a corresponding cutout formed at the lower end 210A of jaw backing structure. Then, the lower end 214A of the jaw die 214 is placed into contact with the die retainer 228 such that a first mating surface 240 located on the rear face 236 of the jaw die abuts and rests on a second mating surface 242 located on the die retainer. A retaining fastener 230A (FIG. 4) is then inserted, preferably by personnel located safely outside the crusher frame 202 and crushing chamber 204, through a rear surface of the jaw backing structure 210, through the rear flange 238, and then into the lower end 214A of the jaw die 214. Preferably, the second mating surface 242 includes a shelf-like surface onto which the first mating surface 240 of the jaw die 214 may rest in order to provide positive and secure placement of the jaw die on the jaw backing structure. In one embodiment of the die retainer 228 that is shown in FIG. 4A, the first and second mating surfaces 240, 242 are each flat or horizontal (as seen in FIG. 4A), which would allow the jaw die 214 to slide laterally from left to right when being mounted to the jaw backing structure 210.

On the other hand, in FIG. 4B, the first and second mating surfaces 240, 242 are each angled. As a result of the angled mating surfaces 240, 242, once the jaw die 214 is placed onto the die retainer 228, the jaw die preferably automatically slides laterally from left to right (as seen in FIG. 4B) down the angled surface into engagement with the jaw backing structure 210. Thus, the second embodiment shown in FIG. 4B provides a die retainer 228 having a corresponding pair of angled or wedge-shaped mating surface 240, 242 that includes leading ends 240A, 242A that are positioned vertically higher than trailing ends 240B, 242B. This arrangement, best shown in the operational position of FIG. 7, ensures that the retaining wedge 224 is completely shielded from the crushing chamber 204 by the body of the jaw die 214, protecting the wedge from abrasive wear and allowing it to be a reusable, non-wear component.

Now, with reference to FIG. 4C and as further detailed below, like the lower end 214A of the jaw die 214, the upper end 214B is also preferably removably and securely mounted to the jaw backing structure (not shown) using the jaw die retention system of the present invention. Wedge 224 is sized and configured to be placed into a cutout formed in a rear surface of upper end 214B of the jaw die 214. More particularly, the upper end 214B of the jaw die 214 is placed into contact with the wedge 224 such that a first mating surface 242 located on the rear face 236 of the jaw die provides a surface for a second mating surface 244 of wedge 224 to contact and rest. Preferably, jaw die 214 and wedge 224 have a corresponding pair of angled or wedge-shaped mating surfaces 242, 244 that includes leading ends 242A, 244A that are positioned vertically lower than trailing ends 242B, 244B. These angled surfaces assist in the wedge 224 locking together with the jaw 214.

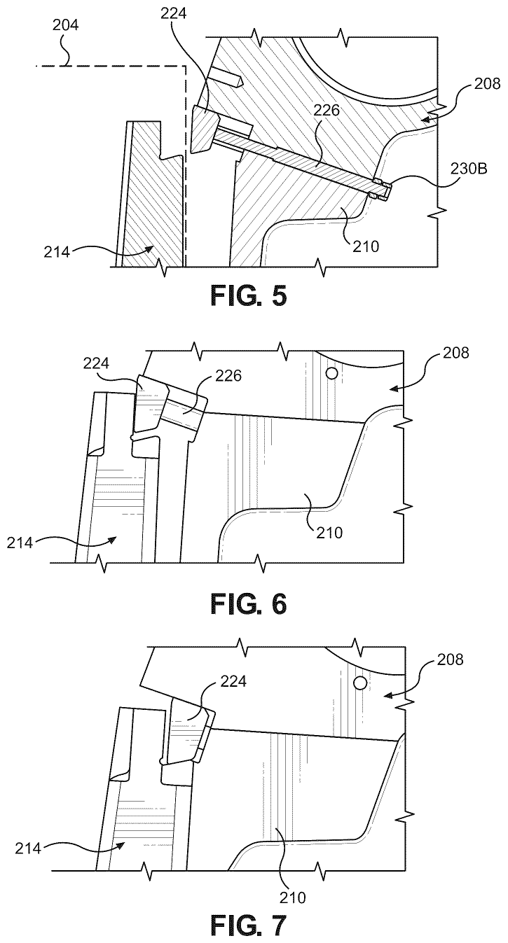

With reference to FIGS. 4A-4C and FIGS. 5-7, in use, the wedge 224 is selectively movable between a “service” position (shown in FIG. 5), where the jaw die 214 may be replaced, and an “operating” position (shown in FIG. 7), where the jaw die is located when the jaw crusher is in operation. To install a jaw die 214, the wedge 224 is placed in the service position. Once the wedge 224 is placed in the service position, a replacement jaw die 214 is lowered from vertically overhead into the crushing chamber 204 between the stationary jaw 206 and the movable jaw 208. The lower end 214A of the jaw die 214 is placed into engagement with the die retainer 228, which is mounted to the jaw backing structure 210, such that mating surface 240, 242 are in contact with one another and the weight of the jaw die is resting on the die retainers 228. Next, the upper end 214B of the jaw die 214 is leaned against the wedge 224 such that the mating surfaces 242, 244 are adjacent one another. Next, the jack bolts 232 are backed out until they are no longer in contact with the wedge 224, which permits the movement of the wedge 224 and wedge bolt 226. Next, retaining nuts 230B that are threaded onto the wedge bolt 226 are torqued down, which draws the wedge bolt and the wedge 224 towards the jaw backing structure 210. As a consequence of the inclination of the wedge bolt 226, when the wedge bolt is drawn towards the jaw backing structure 210, the wedge 224 is moved laterally towards the jaw backing structure and simultaneously vertically downwards. This combined downwards and lateral motion causes the second mating surface 244 of the wedge 224 to come into contact with the first mating surface 242 of the jaw die 214. Advantageously, as a result of the correspondingly angled surfaces 242, 244 formed between leading ends 242A, 244A and trailing ends 242B, 244B, the wedge becomes “locked” into engagement with the jaw die 214, which engagement allows the wedge to pull the jaw die into position against the jaw backing structure 210.

On the other hand, to remove a jaw die 214, the above-described process is reversed. With the wedge in the operating position, the retaining nuts 230B pulling the wedge bolt 226 and wedge 224 into place against the jaw backing structure 210 are loosened and, optionally, removed. This allows the wedge to be freely movable. Before advancing the jack bolts, lifting shackles (or other lifting means) are installed from above, the rigging is attached, and tension is applied to support the weight of the jaw die 214. The jack bolts 232 are then torqued down (i.e., threaded further) into the threaded openings behind the wedge 224 until they make contact with the wedge. With continued torquing, the jack bolts 232 come into contact with the wedge 224 and push it away from the jaw backing structure 210, which disengages the wedge from the jaw die 214 (i.e., to the service position). With the jaw die 214 securely held by the rigging and pushed into the service position, it can then be lifted and removed. It is noted that the jack bolts 232 are simply one way for carrying out this process. A person of skill in the art would understand that other similar mechanisms may be used in place of jack bolts. For example, linear actuators, hydraulic cylinders, or any other linear motion device having sufficient force to drive the wedge 224 away from the jaw backing structure 210 may be used as well. As the jacking member pushes the upper end of the jaw die outward, the jaw die pivots on the die retainer which acts as a fulcrum, moving the die into the service position. An advantage of using jack bolts and other similar devices in this manner to hold the jaw die 214 away from the jaw backing structure 210 is that it correctly and safely positions the jaw die in a position and orientation that is well suited for being raised and lowered into the crushing chamber 204.

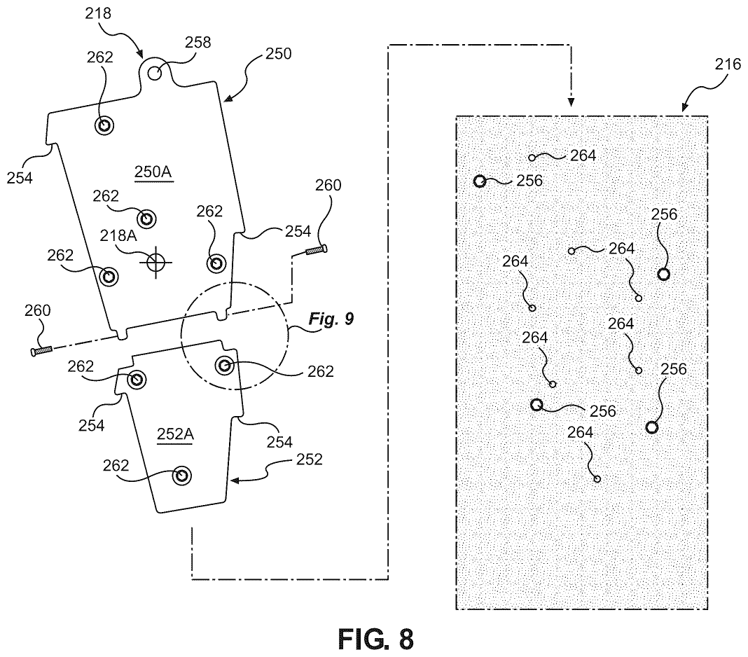

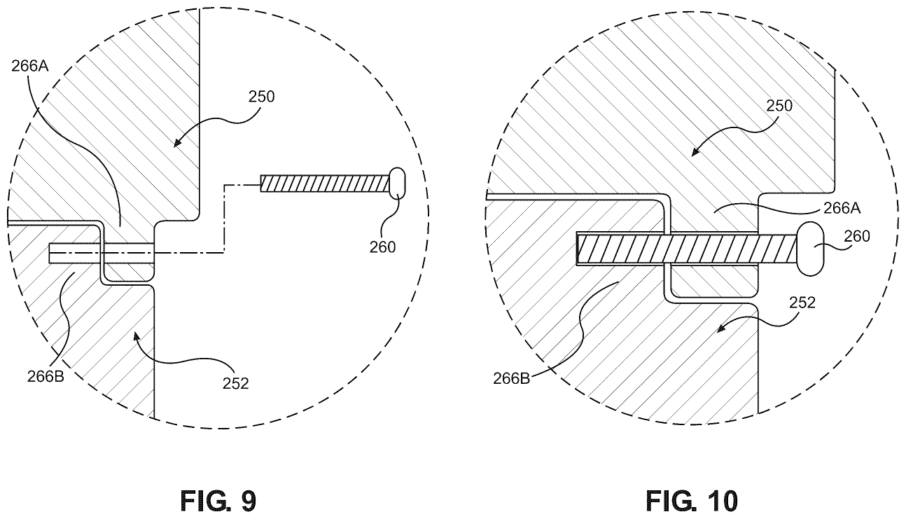

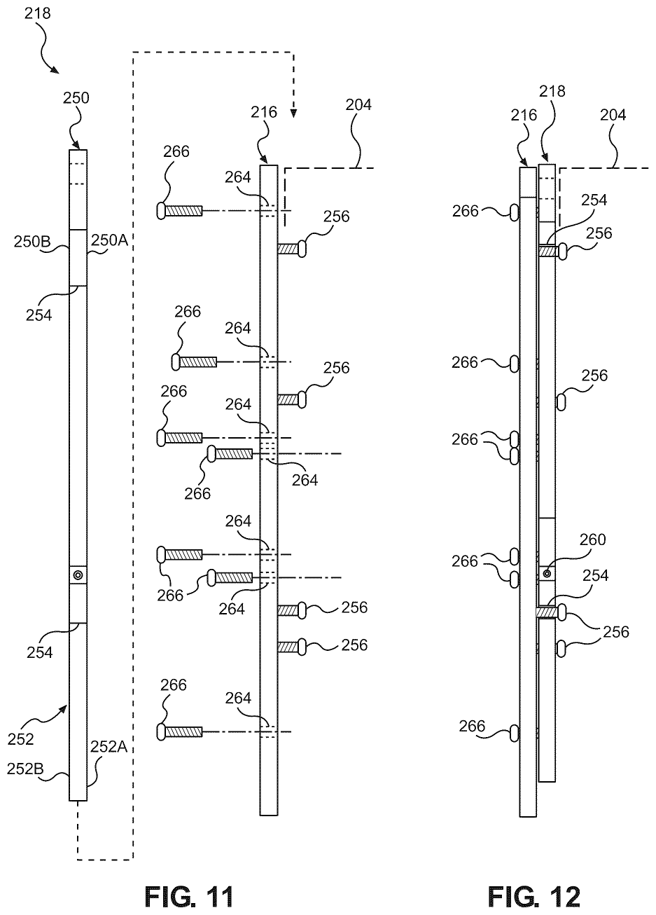

Referring again to FIGS. 2 and 2A and referring further to FIGS. 8-12, the second wear component system of the present invention, a liner assembly system, will be described. This system pertains to the removable wear liner 218 (also referred to as a cheek plate, side liner, or liner assembly) that protects the sidewalls 216 of the crushing chamber 204. Like the jaw die retention system described above, a primary advantage of the liner assembly system is that it enables complete installation and removal of the wear liner 218 without requiring personnel to enter the crushing chamber 204.

As best shown in FIG. 8, the wear liner 218 is preferably a liner assembly comprising at least an upper liner segment 250 and a lower liner segment 252. However, in other embodiments, the wear liner 218 may be formed from a single liner segment or more than two liner segments. To facilitate precise placement, the lower liner segment 252 is provided with at least two or more locating tabs 254 that preferably extend laterally outward from opposing sides of each segment 250, 252. Each segment 250, 252 has a front crushing face 250A, 252A that is configured to be contacted by material passing through the jaw crusher. Next, an opposing rear mounting face 250B, 252B that is positioned against the sidewall 216. The upper and lower liner segments 250, 252 are preferably fabricated from a durable, wear-resistant material, such as manganese steel.

To enable the locating function, the sidewall 216 of the crusher frame 202 is fitted with a corresponding plurality of locating pins 256 that extend into the crushing chamber 204. These locating pins 256 are positioned to engage the locating tabs 254 during installation as the liner segments 250, 252 are lowered vertically into the crushing chamber. The locating pins 256 are preferably simple, robust components such as threaded fasteners, for example, socket head cap screws, that are threaded into the sidewall 216 and that preferably reman in place during operation of the jaw crusher and while the liners 250, 252 are replaced.

To enable handling and installation of the assembly, the liner assembly 218 includes an integrated lifting hole 258, preferably located in the upper liner segment 250. This lifting hole 258 is configured to receive a lifting shackle (not shown) or other lifting equipment. Crucially, the integrated lifting hole 258 is positioned substantially above the center of mass 218A of the entire liner assembly 218 (i.e., including the upper liner segment 250 and lower liner segment 252). As a result, when the assembly 218 is lifted from this single point 258, it hangs in a stable and predetermined vertical orientation, which is essential for safely and consistently guiding it into and out of the narrow crushing chamber 204.

The upper liner segment 250 and lower liner segment 252 are removably joined by one or more connection fasteners 260. In a preferred embodiment, the connection fasteners 260 connect the segments 250, 252 with sufficient looseness to allow for limited independent movement between them. This is advantageous as it accommodates manufacturing tolerance stack-ups and also allows for the lower liner segment 252 to be independently replaced, as it typically experiences a higher rate of wear. In the illustrated embodiment, tabs 266A, 266B are provided on upper liner segment 250 and lower liner segment 252, respectively. Preferably, fastener 260 passes through an opening provided in tab 266A and is then bottomed out in tab 266B in lower liner segment 252. Fastener 260 is preferably long enough that a portion of the fastener extends outwards from tab 266A that is long enough to allow the end of the fastener to be easily cut when upper and lower liner segments need to be separated from one another, such as during a jaw die replacement procedure.

The method of installing the liner assembly 218 is depicted in FIGS. 8, 11 and 12. Lifting equipment is attached to the lifting hole 258, and the liner assembly 218 is lowered into the crushing chamber 204. To facilitate the engagement between the locating tabs 254 and pins 256, each locating tab preferably includes a beveled guide surface on its leading edge. As the liner assembly descends, these beveled guide surfaces make contact with the locating pins 256, which automatically guides the liner assembly 218 into its precise final desired position. The assembly 218 is lowered until a contact surface of the locating tabs 254 comes to rest against or on top of the locating pins 256, which then support the full weight of the liner assembly 218. In this seated position, a plurality of upper and lower fastener holes 262 in the liner assembly 218 are perfectly aligned with corresponding frame fastener holes 264 in the sidewall 216. An operator, positioned entirely outside the crusher frame 202, can then install and tighten frame fasteners 266 through the aligned holes to secure the assembly. In a preferred embodiment, the upper liner segment 250 includes four upper fastener holes and the lower liner segment 252 includes three lower fastener holes.

Removal of the liner assembly 218 is achieved by reversing the process. Frame fasteners 266 are removed from the exterior of the crusher frame 202. Lifting equipment is attached to the lifting hole 258, and the liner assembly 218 is lifted vertically out of the crushing chamber.

In an alternative maintenance method, only the lower liner segment 252 may be replaced. This is achieved by removing the frame fasteners 266, disconnecting the connection fasteners 260 that join the two segments, and removing only the worn lower liner segment 252. A replacement lower liner segment can then be installed using the locating pins 256 for alignment and reconnected to the in-service upper liner segment 250.

By combining the jaw die retention system and the liner assembly system in a single jaw crusher 200, a comprehensive solution is provided wherein all major wear components within the crushing chamber can be safely and efficiently replaced by one or more operators located entirely outside the crusher, representing a fundamental improvement in crusher maintenance safety and operational uptime.

What is claimed is:

1. A liner assembly for a jaw crusher comprising:
an upper liner segment and a lower liner segment;
at least one connection fastener connecting the upper liner segment to the lower liner segment, the liner assembly defining a plurality of fastener holes; and
at least one locating feature disposed on at least one of the upper or lower liner segments,
wherein the at least one locating feature is configured to engage a corresponding locating feature on the jaw crusher to automatically position the liner assembly such that the plurality of fastener holes are aligned with corresponding fastener hole openings in the crusher frame, thereby preparing the liner assembly for installation onto the jaw crusher without requiring personnel to enter a crushing chamber thereof.

2. The liner assembly of claim 1, wherein the at least one locating feature comprises at least one upper locating tab extending laterally outward from each opposing side of the upper liner segment and at least one lower locating tab extending laterally outward from each opposing side of the lower liner segment.

3. The liner assembly of claim 2, wherein the corresponding locating feature on the crusher frame of the jaw is a locating pin extending into the crushing chamber and providing a contact surface configured to receive and allow the locating pins to rest on when the liner assembly is fully seated in the jaw crusher.

4. The liner assembly of claim 3 wherein each of the locating tabs includes a beveled guide surface on a leading edge configured to contact and slide along one of the locating pins during installation.

5. The liner assembly of claim 1, further comprising an integrated lifting hole positioned substantially above a center of mass of the liner assembly, such that the liner assembly maintains a predetermined orientation when suspended therefrom.

6. The liner assembly of claim 1, further comprising a plurality of frame fasteners, each configured to extend from an exterior of the crusher frame, through one of the corresponding fastener hole openings, and into one of the plurality of fastener holes to secure the liner assembly to the jaw crusher.

7. The liner assembly of claim 1, wherein the at least one connection fastener is configured to connect the upper liner segment to the lower liner segment with sufficient looseness to allow limited independent movement between the segments.

8. The liner assembly of claim 1, wherein the at least one connection fastener is positioned such that, when the liner assembly is installed in a jaw crusher adjacent to a jaw die, the at least one connection fastener is shielded from the crushing chamber by the jaw die.

9. The liner assembly of claim 1, wherein the at least one connection fastener comprises a sacrificial bolt having a length sufficient to, when fully inserted into the upper liner and lower liner, provide an exposed portion configured to be severed to permit independent removal of the lower liner segment.

10. The liner assembly of claim 1, wherein the lower liner segment is configured to wear at a faster rate than the upper liner segment and is independently replaceable and the upper liner segment is configured to remain attached to the jaw crusher while the lower liner segment is removed and replaced.

11. A jaw crusher system, comprising:
a crusher frame defining a crushing chamber and having an interior sidewall;
a plurality of locating pins installed in the interior sidewall of the crusher frame;
a liner assembly comprising an upper liner segment and a lower liner segment connected together, the liner assembly having an integrated lifting hole and a plurality of locating tabs; and
a plurality of frame fasteners extending through the crusher frame from an exterior side and into aligned fastener holes in the liner assembly and the crusher frame,
wherein the locating tabs are configured to engage the locating pins to align the liner assembly such that the fastener holes in the liner assembly align with the fastener holes in the crusher frame, thereby enabling installation and removal of the liner assembly without personnel entering the crushing chamber.

12. The jaw crusher system of claim 11, wherein the plurality of frame fasteners are accessible and operable exclusively from the exterior side of the crusher frame.

13. The jaw crusher system of claim 11, wherein the locating tabs include beveled guide surfaces that are configured to contact the locating pins during lowering of the liner assembly to guide the liner assembly into alignment as the liner assembly descends.

14. A method of installing a liner assembly in a jaw crusher, comprising:
providing a jaw crusher frame having a plurality of locating pins installed in an interior sidewall and a plurality of frame fastener holes accessible from an exterior side of the frame;
providing a liner assembly comprising an upper liner segment connected to a lower liner segment, the liner assembly having an integrated lifting hole and a plurality of locating tabs;
attaching lifting equipment to the integrated lifting hole from above the jaw crusher;
lowering the liner assembly as a single unit into a crushing chamber of the jaw crusher;
engaging the locating tabs with the locating pins, thereby automatically positioning the liner assembly such that fastener holes in the liner assembly align with the frame fastener holes; and
installing frame fasteners through the aligned fastener holes from the exterior side of the frame to secure the liner assembly,
wherein the entire installation is performed without personnel entering the crushing chamber.

15. The method of claim 14, wherein engaging the locating tabs with the locating pins comprises contacting beveled guide surfaces on the locating tabs against the locating pins, the beveled guide surfaces guiding the liner assembly into alignment as the liner assembly is lowered.

16. The method of claim 14, further comprising a step of removing the liner assembly by: removing the frame fasteners from the exterior side of the frame; attaching lifting equipment to the integrated lifting hole; and lifting the liner assembly out of the crushing chamber as a single unit; wherein the removal step is performed entirely without personnel entering the crushing chamber.

17. The method of claim 14, further comprising replacing only the lower liner segment by: disconnecting the upper liner segment from the lower liner segment while the upper liner segment remains installed in the jaw crusher; removing the lower liner segment from the crushing chamber; installing a replacement lower liner segment using the locating pins for alignment; and reconnecting the upper liner segment to the replacement lower liner segment.
